(19) United States
(12) Patent Application Publication
(10) Pub. No.: US 2011/0029292 A1
(43) Pub. Date: Feb. 3, 2011

(54) CIRCUIT ANALYSIS

(76) Inventors: Michel Schellekens, County Cork (IE); Rachit Agarwal, Cork (IE); Emanuel Popovici, Cork (IE)

Correspondence Address: JACOBSON HOLMAN PLLC, 400 SEVENTH STREET N.W., SUITE 600, WASHINGTON, DC, 20004, US

(21) Appl. No.: 12/736,505

(22) PCT Filed: Apr. 15, 2009
(86) PCT No.: PCT/IE2009/000017

§ 371 Date: Oct. 14, 2010

(30) Foreign Application Priority Data
Apr. 15, 2008 (IE) 2008/0280

(51) Int. Cl. G06F 17/50; G06F 7/60

(52) U.S. Cl. 703/2

(57) ABSTRACT

A power estimation tool (1) receives as inputs a netlist (2) for a circuit and a library (3) of power models having values for power consumption of circuit components. It stores estimated values for components which are not randomness-preserving, and accurate values for components which are randomness-preserving. A component is randomness-preserving if input and output fixed length strings are random, in which each element in a sequence has an equal probability to occur. The values in the library (3) for randomness-preserving components are for small, low-level, components and are exact. The latter values ma for example be provided in specifications for standard low-level components such as XOR gates. The tool (1) feeds as an output average power consumption for the whole target circuit into a circuit design process (4). The input to the design process may be used in iterative cycles in which there is dynamic change of a netlist so that a target circuit can be optimized for power efficiency.

### FIELD OF THE INVENTION

The invention relates to circuit analysis, particularly analysis of average power consumption of digital circuits, and to production of digital circuit fabrication instructions.

### PRIOR ART DISCUSSION

With the increase in computational complexity of digital circuits, minimization of power consumption is becoming a very important task and poses particular difficulties.

Also, due to the proliferation of battery-operated computing and/or communications devices with embedded (hardware-software) circuits, power consumption became a very hard constraint in the design process. Switching, particularly dynamic switching, is typically a major source of power dissipation. Another major source is short circuit current and leakage current.

Maximum power consumption is related to reliability of the digital system. Although many documents refer to power, in fact they mean energy. Energy E=P*t, where P means power and t is timing, is important as it directly relates to length of battery life. In this specification we use the term “average power consumption” or “average power” to mean energy consumption of the digital circuit over a period of time.

In order to minimize energy consumption it is required to determine both timing and power consumption. Generally these can be only measured once the circuit is being built. Due to fabrication cost issues, it is necessary to estimate efficiently both power and timing throughout the design flow (that is from the initial specification of the functionality until the circuit is fabricated) so that one can choose the best energy-aware option in the design search space.

Solving the estimation problem early in the design process and fast is crucial then to optimize power, timing and hence to minimize energy consumption. However, accurate estimation is difficult and requires considerable processor computational time. This translates into increased time to market or increased cost for the final digital circuit (or “chip”).

The invention is directed towards providing improved electronic circuit analysis with a fast and exact average power estimation.

Another objective is to provide for enhanced circuit design to achieve a circuit with lower power consumption and a shorter design cycle

### SUMMARY OF THE INVENTION

According to the invention there is provided a method for estimating average power consumption of a target digital circuit, the method being performed by an analysis tool comprising a data input interface, a processor, and a data output interface, the method, comprising the steps of:
(a) identifying components of the target digital circuit;
(b) identifying which of the components are randomness-preserving by monitoring inputs and outputs of each component, in which a component is randomness-preserving if input and output fixed length strings are random, in which each element in a sequence has an equal probability to occur;
(c) determining average power consumption, P(i), of each component which is not randomness-preserving by accessing a library of component models to read estimated average power consumption P(i);
(d) determining average power consumption, P(i), of each component which is randomness-preserving by decomposing the component into sub-components which are randomness-preserving and for which exact average power characterization is stored, and adding the sub-component average power values on the basis of compositionality to provide a component-level average power consumption P(i); and
(e) combining the average power estimation values from steps (c) and (d) for all of the components.

In one embodiment, step (a) is performed by automatic analysis of a target circuit netlist

In one embodiment, the step (b) includes analysing input binary strings of each component of the target digital circuit.

In one embodiment, the binary strings are analysed to determine if they comply with the following conditions for randomness-preservation:
the input binary strings form a random collection,
the output binary strings form a random collection, and
the number of input vectors=the number of output vectors, whereby for every input there exists only one output.

In one embodiment, the processor further determines that a component is randomness preserving if the input strings satisfy:
(i) consisting of all possible strings of a fixed length;
(ii) there can be repeated binary strings; and
(iii) each string repetition is repeated a constant number of times.

In one embodiment, the processor performs step (e) by:
finding the number of inputs (ni) and number of outputs (no) of each randomness-preserving component.
computing multiplicities of ‘0’ and ‘1’ using the formula:

K(i)=2̂(ni−no)K(i−1) i.
where K(i−1) is the multiplicity of the preceding component, and
using said multiplicity value when combining the average power values per component.

In one embodiment, the processor performs step (e) by performing a weighted addition to generate data representing overall average power consumption of the circuit.

In one embodiment, the weighted addition is performed according to the algorithm:

P(s)=ΣP(i)K(i−1)
where, P(i) is the power consumption of ith component and K(i−1) is the multiplicity value.

In another embodiment, the target digital circuit is an adiabatic circuit.

In another aspect, the invention provides a method of generating fabrication instructions for a target digital circuit, the method being performed by a processor and comprising the steps of:
(i) generating a data estimate of the average power consumption of the target digital circuit according to a method as defined above in any embodiment, in which the netlist is an initial netlist;
(ii) modifying the initial netlist according to the data outputted in step (i), to provide a subsequent netlist and
(iii) performing step (i) using the subsequent netlist,
(iv) repeating steps (ii) and (iii) for each of zero or more further subsequent netlists, and
(v) processing a netlist which yields the lowest average power consumption for generating fabrication instructions for the corresponding target digital circuit.

In a further aspect, the invention provides a design tool for estimating average power consumption of a target digital circuit, the tool comprising an input interface adapted to receive a netlist for the target digital circuit, a processor adapted to perform the steps of a power estimation method as defined above in any embodiment, and an output interface for providing the average power data as an output.

In another aspect, the invention provides a system for generating fabrication instructions for a target digital circuit, the system. comprising a design tool as defined above in any embodiment, and a processor for processing a netlist which yields lowest power consumption to provide fabrication instructions for the corresponding target digital circuit.

The invention also provides a computer program product, comprising a computer usable medium having a computer readable program code embodied therein, said computer readable program code being adapted to be executed to implement a method for estimating average power consumption of a target digital circuit, said method comprising:
(a) identifying components of the target digital circuit;
(b) identifying which of the components are randomness-preserving by monitoring inputs and outputs of each component, in which a component is randomness-preserving if input and output fixed length strings are random, in which each element in a sequence has an equal probability to occur;
(c) determining average power consumption, P(i), of each component which is not randomness-preserving by accessing a library of component models to read estimated average power consumption P(i);
(d) determining average power consumption, P(i), of each component which is randomness-preserving by decomposing the component into sub-components which are randomness-preserving and for which exact average power characterization is stored, and adding the sub-component average power values on the basis of compositionality to provide a component-level average power consumption P(i); and
(e) combining the average power estimation values from steps (c) and (d) for all of the components.

### DETAILED DESCRIPTION OF THE INVENTION

### Brief Description of the Drawings

The invention will be more clearly understood from the following description of some embodiments thereof, given by way of example only with reference to the accompanying drawings in which: —

FIG. 1 is a block diagram showing a power estimation tool of the invention and its interfaces with other components of a typical design flow of a digital circuit; and

FIG. 2 shows four examples of circuit components as determined by the tool at an early stage of its operation.

### DESCRIPTION OF THE EMBODIMENTS

### Overview

In the following description, when referring to power, we mean dynamic power, which typically includes primarily switching power.

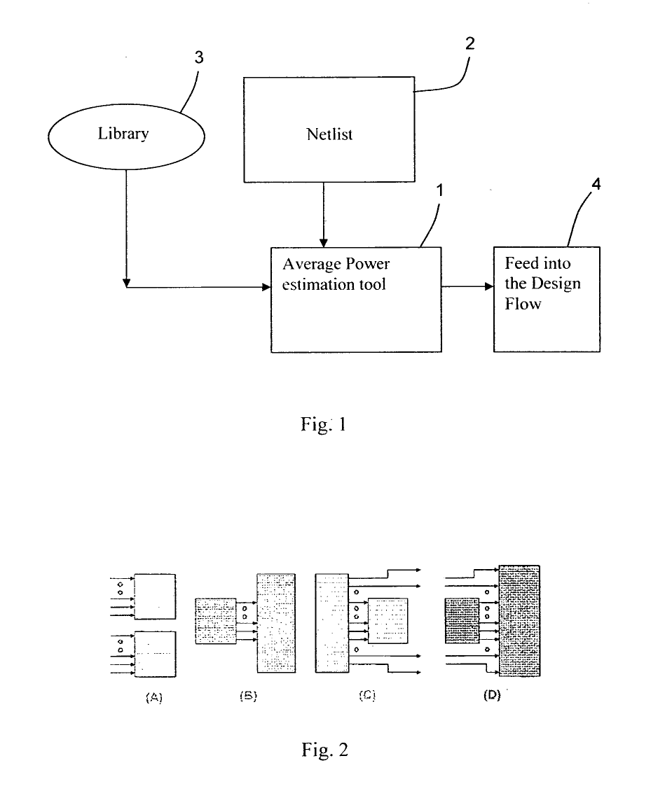

Referring to FIG. 1 a power estimation tool 1 receives as inputs a netlist 2 for a circuit and a library 3 of power models having values for power consumption of circuit components. It stores estimated values for components which are not randomness-preserving, and accurate values for components which are randomness-preserving. The manner in which a component is determined to be randomness-preserving is described in detail below. The values in the library 3 for randomness-preserving components are for small, low-level, components and are exact. The latter values may for example be provided in specifications for standard low-level components such as XOR gates.

The tool 1 feeds as an output average power consumption for the whole target circuit into a circuit design process 4. The input to the design process may be used in iterative cycles in which there is dynamic change of a netlist so that a target circuit can be optimized for power efficiency.

The tool 1 in one embodiment comprises at a hardware level a conventional desktop computer with a general purpose processor programmed to perform the average power estimation and to interface with the other components in the digital circuit design flow.

The processor of the tool 1 is programmed to perform the following main steps:
Identify components of the circuit from the netlist. It then groups the components into those which are randomness-preserving and those which are not. It does this by monitoring inputs, functionality, and outputs of the target digital circuit. A component of the digital circuit is randomness-preserving if input and output fixed length strings are random, i.e. each element in the string has equal probability to occur.
Determine average power consumption, P(i), of each component. For the non randomness preserving components the tool uses the library 3 of estimated power characterization data. For the randomness-preserving components the processor decomposes these components into smaller sub-components which are randomness-preserving and for which the exact average power characterization is stored in the tool.
Processing the P(i) data, using compositionality (described in detail below), via a weighted addition to generate data representing overall average power consumption of the target digital circuit.

The tool 1 determines power consumption data at RTL and gate level for some classes of digital circuits.

The tool 1 provides a fast feedback on the power efficiency of the target digital circuit. This reduces the overall design time and guides the searching of the design space for the optimum components.

### Method Implemented by the Tool 1

In more detail the main functional steps performed by the tool 1 are as follows.

The main inputs to the tool 1 are a netlist from which the tool 1 determines:
functionality of the target digital circuit,
functionality of each component in the structural view of the system, and
internal connections between its components.

The tool 1 commences by dividing the target digital circuit into n>=2 components by analysis of the netlist.

It checks which of these components are randomness-preserving. This is done by monitoring the input and output strings as set out in detail under the relevant heading below.

For each component which is randomness-preserving the tool 1 performs the following to determine a value K(i−1) representing the average number of times the component will be used.
b. Find the number of inputs (ni) and number of outputs no of each component, according to the netlist.
c. Compute the multiplicities of ‘0’ and ‘1’ using the formula:

K(i)=2̂(ni−no)K(i−1) i.
ii. where K(i−1) is the multiplicity of the preceding component
   The number of times a component is used then is given by K(i−1)

Find the estimated average power consumption P(i) of each component which is not randomness-preserving using the library 3 of power models. Also, use the library to determine a value for average power consumption of each randomness-preserving sub-component.

Generate an accurate estimation of the average power consumption of the complete target digital circuit by:

P(s)=ΣP(i)K(i−1)

Where, P(i) is the power consumption value of ith component and K(i−1) is the multiplicity value as computed above, and it is given a nominal value for each randomness-preserving component.

The main output of the tool 1 is average-case power consumption estimation of the complete target digital circuit. Hence, the tool can be used for part of system redesign in order to optimize the power consumption of the complete target digital circuit based on a re-design-re-compute iteration strategy. It could guide the designer during the design process to find the best components for system power optimization. It can also provide inputs to a tool which does hardware-software partitioning to optimize other constraints.

### Determining if a Component is Randomness-Preserving

A collection of binary strings in the input or the output of the component is random if it has the following properties:
1) It consists exactly of all possible strings of a fixed length, the collection “spans the complete space”.
   Example:
      for strings of length 2, this would mean all strings of length 2 in the collection, i.e. the strings: 01,10,00 and 11
   There are 2 to the power 2 (i.e. 4) such strings, in this example.
   In general, for strings of size k, to span the entire space, the tool 1 needs to have all strings of this size, i.e. 2 to the power k.
   In that case we say that the collection of strings spans the whole space.
2) In the collection there can be repeated binary strings.
3) However, each string repetition needs to be repeated a constant number of times.
   For example, in the following example we have repetitions of strings:
      01, 10, 10, 00, 10, 11, 11 and 01
   However the number of times that the strings are repeated is not a constant: 01 is repeated twice, 10 is repeated three times, 00 occurs only one time and 11 is repeated twice.
   In the following example the number of repetitions is constant:
      01, 10, 10, 00, 01, 00, 11, 11
   Each string occurs exactly twice. So both conditions 2) and 3) are satisfied. So it can be summarized as {{01,10,00,11},2}
   This collection is an example of a random collection of binary strings.
   For an operation which transforms binary strings to binary strings to be randomness preserving, the following must hold:
   The input binary strings form a random collection
   The output binary strings form a random collection
   The number of input vectors=the number of output vectors (for every input there exists only one output)
   Example:
      an operation which transforms the inputs
      00, 01, 10, 11 into the output strings: 0,1,1,0 (such as the EX-OR operation in the paper) is randomness preserving:
      The number of input vectors=the number of output vectors=4 the inputs form a random collection (spans entire space (binary numbers of size 2), constant number of repetitions: 1) the outputs form a random collection (spans entire space (binary numbers of size 1), constant number of repetitions: 2)

In operation of the tool 1, the target circuit is seen as a netlist (or interconnection) of several smaller components called children blocks (which can be themselves blocks built of even smaller blocks). The smallest blocks are called leafs.

The tool 1 uses the library 3 of power models for the leaf components if the parent component is randomness-preserving. It then uses these components to generate the exact average power for parents, until eventually it determines an exact average dynamic power for the circuit (the largest bock). For certain circuits, the power is compositional (see detailed description below), in other words it adds up the dynamic power of individual blocks in a modular manner to determine the power of the entire circuit.

The tool 1 does not need to perform simulation, assuming it has the exact switching models for the leaf blocks. Given that the leaf blocks of randomness-preserving parent blocks are small blocks (could be gates or small logic modules), their average switching can be efficiently and exactly determined using simulations. Without needing to simulate, the tool can compute the switching activity and hence the dynamic power.

For block ciphers, the tool determines the exact average switching power that may enable a new class of side channel attacks and hence some methods to protect against such attacks. It could help to answer the question how to determine a secret key using a minimum number of stimuli and measuring the consumed power and also help in hiding the real average power.

All of these block cipher modules are built using randomness-preserving components (eg. XOR gates, look-up tables or SBoxes, constant finite field multipliers) and one can determine the leaf component average switching and then determine the exact average power consumption for the entire cipher.

Some other randomness-preserving components include finite field arithmetic and modulo arithmetic used in communication systems.

Built-in self-test in design for test is another area which uses randomness-preserving components. Let's assume that the target digital circuit is made of three components: Block A, Block B and Block C. Block A could be autonomous, i.e. it generates only random outputs which are fed into block B. The outputs of the Block B are compacted into a signature in Block C. Here, a linear feedback shift register (block A) is the basis for pseudo-random test vector generations and it is also used in compaction (block C). Power dissipation during testing is important and the tool 1 could be used in determining the average power during testing of a randomness preserving unit (Block B) (i.e. block cipher). A linear feedback shift register is a randomness preserving unit (with empty input or output). The same principle can be also applied to Built In Logic Block Observers (BILBO) used in digital testing.

An application of the tool 1 is determining the average dynamic power for so-called adiabatic circuits (reversible circuits). These circuits promise a very significant power reduction while compared to traditional logic circuits. These circuits are randomness preserving and one can apply compositionality to derive the average dynamic power consumption. The whole emerging area of reversible computing can be considered for average dynamic power estimation using the tool.

Quantum computing is another research domain characterized of a large number of reversible functions and although the technology is not mature, one can predict that our method could be extended to estimate average performance for this class of modules.

All these applications give scope to the estimation methodology of the invention.

### Sets & Randomness

The following describes IO-sets and randomness. We w refer to the number of occurrences of an element in an input set number as the multiplicity of that element.

### IO-Sets:

An IO-set is a finite set-like object in which order is ignored but multiplicity is explicitly significant.

Contrary to sets, IO-sets allow for the repetition of elements. Therefore, {00, 01, 10} and {00, 10, 01} are considered to be equivalent but {00, 01, 01, 10} and {00, 10, 01} differ. The cardinality of an IO-set is the sum of the multiplicities of the distinct elements.

Each IO-set T of |T| elements has an associated set J={j₁, j₂, . . . , jₖ} such that UT=UJ and where each element jᵢεj is repeated Kᵢ times, where 1≦K≧|T| and Σᵢ₌₁^{k}Kᵢ=|T|. It is clear that an IO-set can be represented as a set of points {(j₁,K₁), (j₂, K₂), . . . , (jₖ, Kₖ)}.

Lemma 1: Given any circuit/system/component Θ for which input and output 10-sets are given by T_{Θ} and O_{Θ} respectively, the cardinalities of the two sets are equal, i.e., the following holds:

|T_{Θ}|=|O_{Θ}| (1)

The proof follows from that fact that for every input in a logic circuit, there will be a corresponding output. Some specific outputs may be repeated, hence, making respective multiplicities non-unity but cardinality is just sum of multiplicities.

By defining IO-sets and using Lemma 1, we have basically simplified the analysis of inputs and outputs for any component of the system. The analysis can now be just performed in terms of the IO-set, taking frequency of occurrence (multiplicities) of elements of IO-sets into account.

### Complete IO-Sets:

An IO-set T={(j₁,Kᵢ),(j₁,K₂)(jₖ,Kₖ)} is said to be complete if and only if its elements jᵢ span over the complete space (2ⁿ elements if jᵢ is composed of n-bits).

### Uniform Distribution:

An IO-set T={(j₁,K₁), (j₁,K₂), . . . , (jₖ,Kₖ)} is called uniformly distributed if and only if

∀i,jε{1, 2, . . . , k},Kᵢ=Kⱼ=K (2)

An uniformly distributed IO-set T can hence be written as T={J,K}.

### Randomness:

An IO-set is said to be Random, if it is complete and is uniformly distributed.

Lemma 2: Given any IO-set T and any subset Ts of T, a necessary condition for T being random is that Iₛ is random.

Lemma 2 gives us a necessary condition for all the subsets of a random set T. An immediate corollary of Lemma 2 would be the following:

Corollary 1: Cartesian Product (complete combination, henceforth) of random sets T₁, T₂, . . . , Tₙ is always random.

### Example 1

Consider the input and output IO-sets for an EX-OR Gate. The input and output IO-sets will be defined as:

T_{EX-OR}={(00,1),(01,1),(10,1),(11,1)}

O_{EX-OR}={(0, 2),(1,2)}={{0,1},2}

It is easy to show that both T_{EX-OR} and C_{EX-OR} are Random. This is due to the fact that the outputs ‘0’ and ‘1’ span the complete space {(0,1)} and have equal multiplicities (given by 2 for an EX-OR gate).

### Power, Operations & Compositionality

The following defines various power measurements, IO-compositionality and four kinds of operations to perform the exact analysis.

### Power Measures:

Given a system S and a power measure P, four power measures with respect to input T can be defined as:

The Total Power of S for inputs from T, denoted by P′_{S}(T) is defined as:

$${P}_{S}^{t} ( T ) = {\sum }_{I ∈ T} {P}_{S} ( I )$$

The Best-Case Power of S for inputs from T, denoted by P_{S}^{B}(T) is defined as:

P_{S}^{B}(T)=min{P_{S}(I)|IεT}

The Worst-Case Power of S for inputs from T, denoted by P_{S}^{W}(T) is defined as:

P_{S}^{W}(T)=min{P_{S}(I)|IεT}

The invention importantly determines the Average-Case Power of S for inputs from T, denoted by P̅_{S}(T) is defined as:

$${\overline{P}}_{S} ( T ) = \frac{{P}_{S}^{t} ( T )}{\vert T \vert} = \frac{{\sum }_{I ∈ T} {P}_{S} ( I )}{\vert T \vert}$$

Breakdown of Target Circuit into Components

Given a system (target circuit) S and the set of components C={C₁, C₂, . . . , Cₙ} which compose the system. Also, let Iᵢ be the input to and Oᵢ be the output of component Cᵢ. We define the following operations:
Cᵢ∥Cⱼ refers to the connection of components Cᵢ and Cⱼ if Iᵢ and Iⱼ are independent.
Cᵢ; Cⱼ refers to the connection of components Cᵢ and Cⱼ if and only if Iⱼ=Oᵢ
Cᵢ; Cⱼ⁻ refers to the connection of components Cᵢ and Cⱼ if and only if Iⱼ⊂Oᵢ.
Cᵢ; Cⱼ⁺ refers to the connection of components Cᵢ and Cⱼ if and only if Iⱼ⊃Oᵢ.

Any system can be composed using these four basic operations. A graphical representation of the four operations is presented in FIG. 2. The first kind of operation is referred to as functionally independent components while the final three fall into the category of functionally dependent components.

In the following we study first two kind of operations. While this includes a major class of algorithms implemented in VLSI, this analysis can be extended to formulate the condition for other operations using Lemma 2 and Corollary 1. The idea in that case will be to represent the last two operations as a complete combination of several Cᵢ as a subset or superset of Cⱼ.

### IO-Compositionality)

Given a power measure P, let S denote the system (target circuit) and C₁, C₂ denote arbitrary components of the system S. ∀Cᵢ, CⱼεS, we say that P is IO-Compositional w.r.t. the operation Cᵢ;Cⱼiff

P_{C}_{₁}_{;C}_{₂}(T)=P_{C}_{₁}(T₁)+P_{C}_{₂}(O_{C}_{₁}(T)) (2)

We study IO-Compositionality for Worst-case, Best-case and Average-case in the next section and take IO- to Linear-Compositionality in the next section.

We show that Worst and Best case power are not IO-Compositional, i.e., given the power consumption of components, only bounds can be derived on worst and best case powers. However, average-case power is IO-Compositional.

Lemma 3: Worst-Case Power P_{S}^{W} and the Best-Case Power P_{S}^{B} are not 10-Compositional w.r.t. operation Cᵢ; Cᵢ. Proof: For the Best-Case Power and Worst-Case Power, we observe that for any input IεT, clearly we must have

$$\begin{matrix}{P}_{S}^{B} = {P}_{{C}_{1}}^{B} ( T ) + {P}_{{C}_{2}}^{B} ( {O}_{{C}_{1}} ( T ) ) \leq {P}_{{C}_{1} ; {C}_{2}} ( T ) \\ = {P}_{{C}_{1}} ( T ) + {P}_{{C}_{2}} ( {O}_{{C}_{1}} ( T ) ) \leq {P}_{{C}_{1}}^{W} ( T ) + {P}_{{C}_{2}}^{W} ( {O}_{{C}_{1}} ( T ) )\end{matrix}$$

from which the non TO-Compositionality for Worst-Case and Best-Case follows immediately.

It can be shown that IO-Compositionality for Worst-case and Best-case power consumption can not be achieved in general, i.e., their semi IO-Compositionality inequalities are strict in general. This is illustrated by a counter-example below.

### Example 3

We demonstrate through a realistic, though artificial, example that Worst-case and Best-case power is not IO-Compositional. FIG. 2 illustrates nicely the lack of control one has in guaranteeing IO-Compositionality for the Worst and Best-case power. The problem is that the worst (best) cases for the two components may happen for different elements of the given IO-set.

Theorem 1: The average-case power is IO-Compositional w.r.t. operation Cᵢ;Cⱼ, i.e., for any system S and for any two components C₁, C₂ of S, where C1 operates on an input T and produces the output O_{C}_{ᵢ}(T):

P̅_{C}_{₁}_{;C}_{₂}(T)= P̅_{C}_{ᵢ}(T)+ P̅_{C}_{₂}(O_{C}_{ᵢ}(T)) (4)

### Proof:

$$\begin{matrix}{\overline{P}}_{{C}_{1} ; {C}_{2}} ( T ) = \frac{{\sum }_{I ∈ T} {P}_{{C}_{1} ; {C}_{2}} ( I )}{\vert T \vert} \\ = \frac{{\sum }_{I ∈ T} {P}_{{C}_{1}} ( I ) + {\sum }_{J ∈ {O}_{{C}_{1}} ( T )} {P}_{{C}_{2}} ( J )}{\vert T \vert} \\ = {\overline{P}}_{{C}_{1}} ( T ) + {\overline{P}}_{{C}_{2}} ( {O}_{{C}_{1}} ( T ) )\end{matrix}$$

where the last equality holds from the fact that |T|=O_{C}_{ᵢ}(T)| (Lemma 1).

### From IO- to Linear-Compositionality

It is this IO-Compositionality of Theorem 1 which requires the specific distribution of outputs for computation of power consumption of a component of a system. Ideally, to reduce the design iterations, we would like to have linear compositionality, as defined informally in the introduction.

Lemma 4: The Total P^{t}, Best-Case P^{B}. Worst-Case P^{W} and Average-Case Power P̅(T) is Linearly-Compositional w.r.t. operation Cᵢ∥Cⱼ

The proof follows from the fact that the Input IO-sets for the two components are independent of each other.

To derive a necessary condition for linear compositionality w.r.t. power consumption, let us recall that for random IO-sets T,J,J′, we want:

P̅_{C}_{₁}_{;C}_{₂}(T)=K× P̅_{C}_{₁}(J)+K′× P̅_{C}_{₂}(J′) (5)

i.e., the average power consumption of a sequential combination of two components is an addition of weighted average-power consumption of the components. Without loss of generality, we can assume that input IO-set to component C₇ can be written as T=K×J. In such cases, (5) can be written as:

$${\overline{P}}_{{C}_{1} ; {C}_{2}} ( J ) = {\overline{P}}_{{C}_{1}} ( J ) + \frac{{K}^{′}}{K} \times {\overline{P}}_{{C}_{2}} ( {J}^{′} ) \qquad ( 6 )$$

which can further be extended to:

$${\overline{P}}_{{C}_{1} ; {C}_{2}} ( J ) = {\overline{P}}_{{C}_{1}} ( J ) + {\overline{P}}_{{C}_{2}} ( \frac{{K}^{′}}{K} \times {J}^{′} ) \qquad ( 7 )$$

Comparing (7) with result of Theorem 1, i.e. (4), the necessary condition for equivalence of these two equations is that:

$${O}_{{C}_{1} ; {C}_{2}} ( J ) = \frac{{K}^{′}}{K} \times {J}^{′} \qquad ( 8 )$$

which implies that linear compositionality can be achieved if output IO-set from one component is a random IO-set. Notice that for a nᵢ bit input and n₀ bit output, the value of K′ can be simply derived as K′=2ⁿ^{₁}⁻ⁿ^{₀}×K (K′=2 for example 1). The above result is summarized in the following theorem:

Theorem 2: The average-case power is Linearly Compositional w.r.t. operation Cᵢ;Cⱼ, i.e., for any system S and for any two components C₁, C₂ of S, where C₁ operates on an input T and C₂ operates on an input T′:

P̅_{C}_{₁}_{;C}_{₂}(T)= P̅_{C}_{₁}(T)+ P̅_{C}_{₂}(T′) (9)

if and only if C₁ is randomness preserving.

It will be appreciated that the tool provides a fast feedback on the power efficiency of the design choice of the digital system. It helps in the design for low power/energy searching space. This reduces the overall design time, guides the searching of the design space for the optimum components for energy efficiency and also it provides accurate average power estimation of the most important component of power, the dynamic power.

As described above, the tool 1 is particularly effective if the blocks are randomness-preserving. Such functions, although restrictive, cover some important classes of digital circuits, namely in cryptography such as (but not restricted to) block ciphers (such as IDEA or AES) some hash functions, random/pseudorandom number generators, linear feedback shift registers (LFSR).

The invention is not limited to the embodiments described but may be varied in construction and detail.

1. A method for estimating average power consumption of a target digital circuit, the method being performed by an analysis tool comprising a data input interface, a processor, and a data output interface, the method comprising the steps of:
(a) identifying components of the target digital circuit;
(b) identifying which of the components are randomness-preserving by monitoring inputs and outputs of each component, in which a component is randomness-preserving if input and output fixed length strings are random, in which each element in a string has an equal probability to occur;
(c) determining average power consumption, P(i), of each component which is not randomness-preserving by accessing a library of component models to read estimated average power consumption P(i);
(d) determining average power consumption, P(i), of each component which is randomness-preserving by decomposing the component into sub-components which are randomness-preserving and for which exact average power characterization is stored, and adding the sub-component average power values on the basis of compositionality to provide a component-level average power consumption P(i); and
(e) combining the average power estimation values from steps (c) and (d) for all of the components.

2. The A method as claimed in claim 1, wherein step (a) is performed by automatic analysis of a target circuit netlist

3. The method as claimed in claim 1, wherein the step (b) includes analysing input binary strings of each component of the target digital circuit.

4. The method as claimed in claim 1, wherein the binary strings are analysed to determine if they comply with the following conditions for randomness-preservation:
the input binary strings form a random collection,
the output binary strings form a random collection, and
the number of input vectors=the number of output vectors, whereby for every input there exists only one output.

5. The method as claimed in claim 1, wherein the binary strings are analysed to determine if they comply with the following conditions for randomness-preservation:
the input binary strings form a random collection,
the output binary strings form a random collection, and
the number of input vectors=the number of output vectors, whereby for every input there exists only one output; and
wherein the processor further determines that a component is randomness preserving if the input strings satisfy:
(i) consisting of all possible strings of a fixed length;
(ii) there can be repeated binary strings; and
(iii) each string repetition is repeated a constant number of times.

6. The method as claimed in claim 1, wherein the processor performs step (e) by:
finding the number of inputs (ni) and number of outputs (no) of each randomness-preserving component.
computing multiplicities of ‘0’ and ‘1’ using the formula:
K(i)=2̂(ni−no)K(i−1) i.
where K(i−1) is the multiplicity of the preceding component, and
using said multiplicity value when combining the average power values per component.

7. The method as claimed in claim 1, wherein the processor performs step (e) by performing a weighted addition to generate data representing overall average power consumption of the circuit.

8. The method as claimed in claim 1, wherein the processor performs step (e) by performing a weighted addition to generate data representing overall average power consumption of the circuit; and wherein the weighted addition is performed according to the algorithm:
P(s)=ΣP(i)K(i−1)
where, P(i) is the power consumption of ith component and K(i−1) is the multiplicity value.

9. The A method as claimed in claim 1, wherein the target digital circuit is an adiabatic circuit.

10. The method of generating fabrication instructions for a target digital circuit, the method being performed by a processor and comprising the steps of:
(i) generating a data estimate of the average power consumption of the target digital circuit according to a method as claimed in claim 1, in which the netlist is an initial netlist;
(ii) modifying the initial netlist according to the data outputted in step (i), to provide a subsequent netlist and
(iii) performing step (i) using the subsequent netlist,
(iv) repeating steps (ii) and (iii) for each of zero or more further subsequent netlists, and
(v) processing a netlist which yields the lowest average power consumption for generating fabrication instructions for the corresponding target digital circuit.

11. The design tool for estimating average power consumption of a target digital circuit, the tool comprising an input interface adapted to receive a netlist for the target digital circuit, a processor adapted to perform the steps of a method of claim 1, and an output interface for providing the average power data as an output.

12. The system for generating fabrication instructions for a target digital circuit, the system comprising a design tool of claim 11, and a processor for processing a netlist which yields lowest power consumption to provide fabrication instructions for the corresponding target digital circuit.

13. A computer program product, comprising a computer usable medium having a computer readable program code embodied therein, said computer readable program code being adapted to be executed to implement a method for estimating average power consumption of a target digital circuit, said method comprising:
(a) identifying components of the target digital circuit;
(b) identifying which of the components are randomness-preserving by monitoring inputs and outputs of each component, in which a component is randomness-preserving if input and output fixed length strings are random, in which each element in a string has an equal probability to occur;
(c) determining average power consumption, P(i), of each component which is not randomness-preserving by accessing a library of component models to read estimated average power consumption P(i);
(d) determining average power consumption, P(i), of each component which is randomness-preserving by decomposing the component into sub-components which are randomness-preserving and for which exact average power characterization is stored, and adding the sub-component average power values on the basis of compositionality to provide a component-level average power consumption P(i); and
(e) combining the average power estimation values from steps (c) and (d) for all of the components.
